(19) United States
(12) Patent Application Publication
(10) Pub. No.: US 2022/0320593 A1
(43) Pub. Date: Oct. 6, 2022

(54) METHOD FOR PRODUCING NON-AQUEOUS ELECTROLYTE SECONDARY BATTERY

(71) Applicant: Prime Planet Energy & Solutions, Inc., Tokyo (JP)

(72) Inventors: Akira KOHYAMA, Toyoake-shi (JP); Hideki SANO, Ikeda-shi (JP); Naoto ONODERA, Kobe-shi (JP); Azusa NAKANISHI, Toyota-shi (JP)

(21) Appl. No.: 17/701,682

(22) Filed: Mar. 23, 2022

(30) Foreign Application Priority Data
Mar. 30, 2021 (JP) 2021-057177

(51) Int. Cl. H01M 10/0587; H01M 4/505; H01M 10/44; H01M 50/538

(52) U.S. Cl. CPC H01M 10/0587; H01M 4/505; H01M 10/44; H01M 50/538; H01M 2004/027

(57) ABSTRACT

Provided is a technique for suppressing the formation of highly resistive regions in a wound electrode body. The production method disclosed herein includes a flat-shaped wound electrode body in which a belt-shaped positive electrode plate and a belt-shaped negative electrode plate are wound, with a belt-shaped separator being intervened therebetween, a non-aqueous electrolyte, and a battery case. The positive electrode plate contains a lithium-transition metal composite oxide containing manganese. This production method includes an assembling step S1 of placing the wound electrode body and the non-aqueous electrolyte in the battery case to construct a secondary battery assembly; a first charging step S2 of performing initial charging on the secondary battery assembly such that the battery voltage reaches 3.1 V to 3.7 V; and a discharging step S3 of discharging the secondary battery assembly after the first charging step.

### CROSS REFERENCE TO RELATED APPLICATIONS

This application claims the benefit of foreign priority to Japanese Patent Application No. 2021-057177, filed on Mar. 30, 2021, the entire contents of which are incorporated herein by reference.

### BACKGROUND OF THE DISCLOSURE

### 1. Technical Field

The present invention relates to a method for producing a non-aqueous electrolyte secondary battery.

### 2. Background

Secondary batteries such as lithium ion secondary batteries are currently used in a wide variety of fields such as vehicles and mobile devices. Typical examples of this kind of secondary battery include a non-aqueous electrolyte secondary battery including an electrode body with a positive electrode plate and a negative electrode plate, a non-aqueous electrolyte, and a battery case housing the electrode body and the non-aqueous electrolyte.

In producing a non-aqueous electrolyte secondary battery, a secondary battery assembly in a state where an electrode body and a non-aqueous electrolyte are housed in a battery case is generally charged as initial charging. The initial charging can form a so-called SEI coating on the surface of a negative electrode plate. Meanwhile, gas derived from components in a secondary battery assembly can be produced in the electrode body during initial charging. Such gas production in an electrode body may cause the occurrence of charging unevenness in an electrode body. Thus, technical developments for suppressing the occurrence of charging unevenness derived from gas production have been demanded. Now, WO 2019/044560 is cited as an example of prior art relating to gas production in an electrode body. The method for producing a secondary battery disclosed in this patent literature proposes that a secondary battery precursor is provided in a standing manner such that the secondary battery precursor has an opening at the top in the vertical direction, and initial charging is performed while the produced gas is released from the opening. The patent literature describes that charging unevenness due to bubbles can be sufficiently prevented in a secondary battery precursor by the above production method.

### SUMMARY OF THE INVENTION

By the way, a flat-shaped wound electrode body in which a belt-shaped positive electrode plate and a belt-shaped negative electrode plate are wound with a belt-shaped separator intervened therebetween is mentioned as one example of the above electrode body. The present inventors have newly learned that charging such a wound electrode body can form highly resistive regions containing transition metals (for example, manganese and the like) contained in a positive electrode plate and having a locally high resistance in some regions of the wound electrode body. Then, the present inventors have found that the formation of the highly resistive regions may be derived from gas production during initial charging and that a non-aqueous electrolyte secondary battery provided with a wound electrode body having highly resistive regions formed therein may show poorer battery characteristics (for example, the capacity retention rate or the like).

The present invention has been made for solving such a problem and has an object to provide a technique for suppressing the formation of highly resistive regions in a wound electrode body in a non-aqueous electrolyte secondary battery provided with the wound electrode body.

The production method disclosed herein is a method for producing a non-aqueous electrolyte secondary battery that includes a flat-shaped wound electrode body in which a belt-shaped positive electrode plate and a belt-shaped negative electrode plate are wound, with a belt-shaped separator being intervened therebetween, a non-aqueous electrolyte, and a battery case that houses the wound electrode body and the non-aqueous electrolyte. The positive electrode plate contains a lithium-transition metal composite oxide containing manganese. This production method includes an assembling step of placing the wound electrode body and the non-aqueous electrolyte in the battery case to construct a secondary battery assembly; a first charging step of performing initial charging on the secondary battery assembly such that the battery voltage reaches 3.1 V to 3.7 V; and a discharging step of discharging the secondary battery assembly after the first charging step. The production method having such a constitution can eliminate the variation of the potential in the wound electrode body after the first charging by performing the discharging step. As a result, the formation of highly resistive regions in the wound electrode body can be suppressed.

According to one suitable embodiment of the production method disclosed herein further includes a maintaining step of maintaining the secondary battery assembly at a battery voltage of 3.2 V or lower for at least 12 hours after the discharging step. According to such a constitution, the effect of the technique disclosed herein can be achieved more suitably.

In another suitable embodiment of the production method disclosed herein, the negative electrode plate has a negative electrode core and a negative electrode active material layer formed on the negative electrode core, and the negative electrode active material layer has a length of at least 20 cm in a winding axis direction of the wound electrode body. In producing a non-aqueous electrolyte secondary battery provided with a wound electrode body with such a constitution, the effect of the technique disclosed herein can be achieved suitably.

In another suitable embodiment of the production method disclosed herein, the production method further includes, after the maintaining step, a second charging step of charging the secondary battery assembly such that a battery voltage reaches 3.1 V to 3.7 V. According to such a constitution, the effect of the technique disclosed herein can be appropriately achieved.

In another suitable embodiment of the production method disclosed herein, the production method further includes an aging step of retaining the secondary battery assembly at 15° C. to 30° C. for 6 hours to 72 hours after the second charging step. According to such a constitution, an SEI coating formed on the electrode surface is stabilized, and the protective effect can be maximized.

In another suitable embodiment of the production method disclosed herein, the maintaining step is performed in a condition where the secondary battery assembly is restrained in a thickness direction of the wound electrode body. According to such a constitution, the effect of suppressing the formation of highly resistive regions can be enhanced more greatly.

A non-aqueous electrolyte secondary battery having the following constitution can be preferably produced using the production method disclosed herein. In the non-aqueous electrolyte secondary battery, the battery case includes an exterior body that includes an opening and a bottom part opposite to the opening, and a sealing plate that seals the opening, and the wound electrode body is arranged in the exterior body in a direction such that the winding axis is parallel to the bottom part.

A non-aqueous electrolyte secondary battery having the following constitution can be preferably produced using the production method disclosed herein. In the non-aqueous electrolyte secondary battery, the wound electrode body is provided in plurality and the battery case houses the plurality of wound electrode bodies therein.

A non-aqueous electrolyte secondary battery having the following constitution can be preferably produced using the production method disclosed herein. The non-aqueous electrolyte secondary battery includes a positive electrode current collector and a negative electrode current collector electrically connected to the wound electrode body, a positive electrode tab group including a plurality of tabs protruding from one end in the winding axis direction of the wound electrode body, and a negative electrode tab group including a plurality of tabs protruding from another end in the same direction of the wound electrode body. The positive electrode current collector and the positive electrode tab group are connected, and the negative electrode current collector and the negative electrode tab group are connected.

### BRIEF DESCRIPTION OF THE DRAWINGS

FIG. 1 is a perspective view schematically illustrating a non-aqueous electrolyte secondary battery produced by the production method according to a first embodiment;

FIG. 2 is a schematic cross-sectional view along the line II-II in FIG. 1;

FIG. 3 is a perspective view schematically illustrating a wound electrode body used in the production method according to the first embodiment;

FIG. 4 is a schematic view illustrating a constitution of a wound electrode body used in the production method according to the first embodiment;

FIG. 5 is a schematic view illustrating the changes of the positive electrode potential and the negative electrode potential by the initial charging;

FIG. 6 is a flow chart of the production method of a non-aqueous electrolyte secondary battery in the first embodiment;

FIG. 7 is a perspective view of a restrained body in the production method according to the first embodiment;

FIG. 8 is a schematic view for explaining the changes of the positive electrode potential and the negative electrode potential by the discharging step;

FIG. 9 is a schematic view for explaining the changes of the positive electrode potential and the negative electrode potential by the second charging step;

FIG. 10 is a perspective view of a restrained body in the production method according to a third embodiment; and

FIG. 11 is a top view of a restrained body in the production method according to a fourth embodiment.

### DETAILED DESCRIPTION OF THE PREFERRED EMBODIMENTS

Some suitable embodiments of the technique disclosed herein are described below with reference to drawings. Matters other than those specifically mentioned in the description but necessary for the implementation of the present invention (for example, general constitutions and production processes of secondary batteries not characterizing the technique disclosed herein) may be recognized as design matters for a person skilled in the art based on conventional techniques in the art. The technique disclosed herein can be implemented based on the content disclosed in the present description and a common general technical knowledge in the art.

The term “secondary battery” used in the present description refers to power storage devices in general capable of being discharged and charged repeatedly and encompasses so-called storage batteries (chemical batteries), such as lithium ion secondary batteries, and capacitors (physical batteries), such as electric double-layer capacitors. In the description, the term “active material” refers to a material capable of reversibly occluding and releasing electric charge carriers (for example, lithium ions).

The symbol X represents a “depth direction”, the symbol Y represents a “width direction”, and the symbol Z represents a “height direction” in each figure referred to in the present description. In the depth direction X, F denotes the “front”, and Rr denotes the “rear”. In the width direction Y, L denotes the “left”, and R denotes the “right”. In the height direction Z, U denotes “upward”, and D denotes “downward”. However, these are directions defined for explanatory convenience and not intended to limit the mode of installation of a secondary battery. The expression “A to B” indicating a numerical range in the present description encompasses a meaning of “A or more and B or less”, as well as “over A and below B”.

### First Embodiment

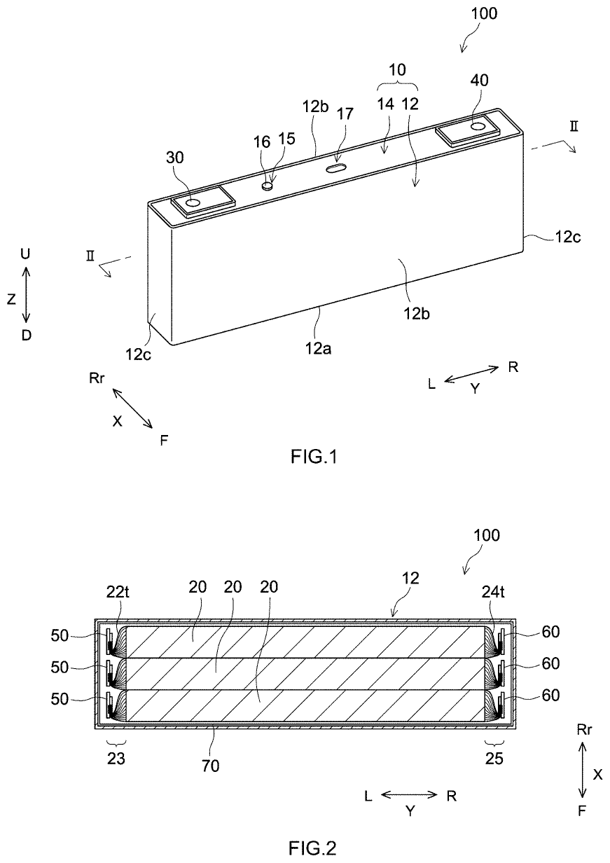

One example of a non-aqueous electrolyte secondary battery produced in the production method disclosed herein is illustrated in FIGS. 1 and 2. Anon-aqueous electrolyte secondary battery 100 includes a wound electrode body 20, a non-aqueous electrolyte (not illustrated), and a battery case 10 housing the wound electrode body and the non-aqueous electrolyte. The non-aqueous electrolyte secondary battery 100 here is a lithium ion secondary battery.

The non-aqueous electrolyte may contain a non-aqueous solvent and a supporting electrolyte. As the non-aqueous solvent, organic solvents such as various carbonates used in a general lithium ion secondary battery may be used without any particular limitations. Specific examples of non-aqueous electrolytes include linear carbonates such as dimethyl carbonate (DMC), ethyl methyl carbonate (EMC), and diethyl carbonate (DEC); cyclic carbonates such as ethylene carbonate (EC), propylene carbonate (PC), butylene carbonate (BC), methyl ethylene carbonate, and ethyl ethylene carbonate; fluorinated linear carbonates such as methyl 2,2,2-trifluoroethyl carbonate (MTFEC); and fluorinated cyclic carbonates such as monofluoroethylene carbonate (FEC) and difluoroethylene carbonate (DFEC). These non-aqueous solvents may be used singly or in a combination of two or more of these.

Examples of supporting electrolytes include LiPF₆, LiBF₄, and the like. The concentration of a supporting electrolyte in the non-aqueous electrolyte may be set within the range of 0.7 mol/L to 1.3 mol/L. The non-aqueous electrolyte may contain other components than the components described above, such as a film-forming agent, including an oxalato complex compound containing a boron (B) atom and/or a phosphorus (P) atom (for example, lithium bis(oxalato)borate (LiBOB)), vinylene carbonate (VC), lithium difluorophosphate, or the like; and a gas-forming agent, including biphenyl (BP), cyclohexylbenzene (CHB) or the like. As long as the effect of the technique disclosed herein is not remarkably impaired, a conventionally known additive such as a thickener and a dispersant.

The battery case 10 includes an exterior body 12 with an opening and a sealing plate (lid) 14 for sealing the opening. The exterior body 12 and the sealing plate 14 of the battery case 10 are integrated by joining the sealing plate 14 on the periphery of the opening of the exterior body 12 to airtightly seal (tightly seal) the battery case 10. The exterior body 12 is a bottomed rectangular tube-shaped rectangular exterior body including the opening, a rectangular bottom part 12a opposite to the opening, a pair of large-area side walls 12b standing from the long sides of the bottom part 12a, and a pair of small area side walls 12c standing from the short sides of the bottom part 12a. The sealing plate 14 is provided with a liquid injection hole 15 for a non-aqueous electrolyte, a gas exhaust valve 17, a positive electrode terminal 30, and a negative electrode terminal 40. The liquid injection hole 15 is sealed with a sealing member 16. The positive electrode terminal 30 and the negative electrode terminal 40 are electrically connected to the wound electrode body 20 housed in the battery case 10. The battery case 10 is, for example, made of metal. Examples of metal materials constituting the battery case 10 include aluminum, aluminum alloys, iron, iron alloys, and the like.

The wound electrode body 20 is a power generation element of the non-aqueous electrolyte secondary battery 100 and is provided with a positive electrode plate, a negative electrode plate, and a separator. In the present embodiment, a plurality (for example, two or more, three or more, or four or more; three in FIG. 2) of wound electrode bodies 20 are housed in the battery case 10 (exterior body 12) so as to be arranged in the depth direction X as illustrated in FIG. 2. As illustrated in FIGS. 1 to 4, the wound electrode bodies 20 are arranged in the exterior body 12 in a direction such that the winding axis WL is parallel to the bottom part 12a. The wound electrode body 20 is housed in the battery case 10 in a state of being housed in the electrode body holder 70. Note that constituent materials of the members constituting the wound electrode body 20 other than the positive electrode plate (such as a negative electrode plate and a separator) are not particularly limited and may be materials that can be used for general non-aqueous electrolyte secondary batteries and do not limit the technique disclosed herein. Therefore, the detailed description about such constituent materials may be omitted in some cases.

The size of the wound electrode body 20 is not particularly limited. That is, the length L1 in the winding axis WL direction of the wound electrode body 20 may be set to, for example, at least 10 cm, at least 20 cm, or at least 30 cm. The above length L1 may be, for example, up to 60 cm, up to 50 cm, or up to 40 cm. In some embodiments, the length L1 is at least 20 cm. The effect of the technique disclosed herein can be suitably achieved especially when the length L1 is at least 20 cm. Note that the above length L1 does not include either the length of the positive electrode tab 22t and the length of the negative electrode tab 24t mentioned below.

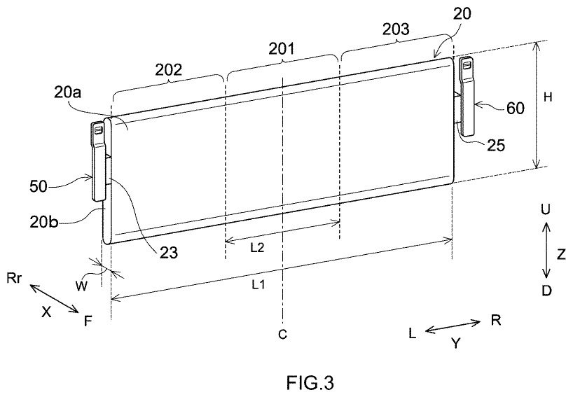

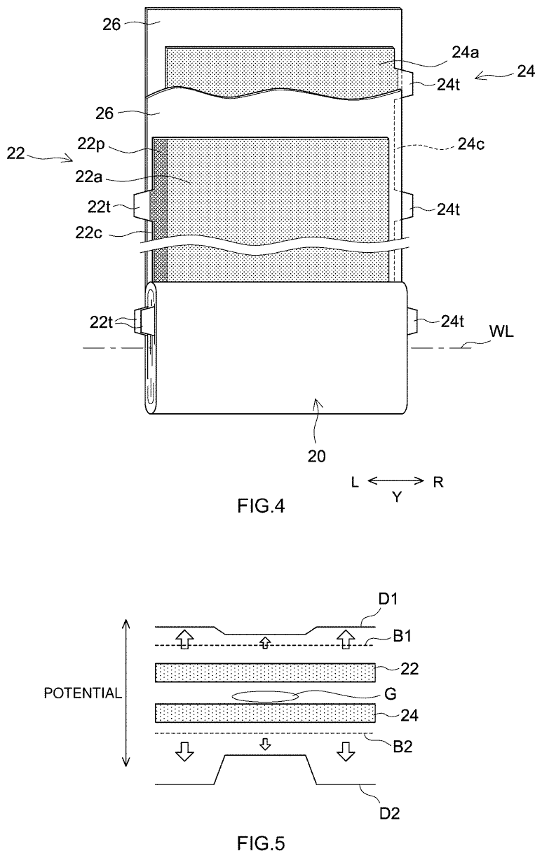

As illustrated in FIG. 4, the wound electrode body 20 includes a positive electrode plate 22 and a negative electrode plate 24. The wound electrode body 20 is a flat-shaped wound electrode body in which a long belt-shaped positive electrode plate 22 and a long belt-shaped negative electrode plate 24 are wound around the winding axis WL orthogonal to the longitudinal direction while a long belt-shaped separator 26 is intervened therebetween. As illustrated in FIG. 3, the wound electrode body 20 has a pair of flat parts 20a and a pair of edges 20b in the width direction Y. An edge 20b is a laminated surface of a positive electrode plate 22, a negative electrode plate 24, and a separator 26, and opened to the outside of the wound electrode body 20.

The positive electrode plate 22 has a long belt-shaped positive electrode core 22c (for example, an aluminum foil, an aluminum alloy foil, and the like) and a positive electrode active material layer 22a secured on at least one surface (preferably both surfaces) of the positive electrode core 22c. Hereinafter, “positive electrode core” may also be termed “positive electrode core body.” Although not particularly restricted, a positive electrode protection layer 22p may optionally be formed on one side edge in the width direction Y of the positive electrode plate 22. A plurality of positive electrode tabs 22t are disposed at one edge (the left edge in FIG. 4) in the width direction Y of positive electrode core body 22c. The plurality of positive electrode tabs 22t each protrude toward one side (the left side in FIG. 4) in the width direction Y. The plurality of positive electrode tabs 22t are disposed at intervals (intermittently) along the longitudinal direction of the positive electrode plate 22. A positive electrode tab 22t is a part of a positive electrode core body 22c and a part (core body exposed part) where a positive electrode active material layer 22a and a positive electrode protection layer 22p of the positive electrode core body 22c are not formed. The plurality of positive electrode tabs 22t are stacked at one edge (the left edge in FIG. 4) in the width direction Y and constitutes a positive electrode tab group 23 including a plurality of positive electrode tabs 22t. A positive electrode current collector 50 is joined to the positive electrode tab group 23 (see FIGS. 2 to 4).

The size of the positive electrode plate 22 is not particularly restricted and may be set such that the above length L1 of the wound electrode body 20 can be achieved. That is, the length of the positive electrode plate 22 in the winding axis WL direction may be set to, for example, at least 10 cm, at least 20 cm, or at least 30 cm. The above length may be, for example, up to 60 cm, up to 50 cm, or up to 40 cm. Note that the above length does not include the length of the positive electrode tab 22t.

The positive electrode active material layer 22a may contain a positive electrode active material, a binder, and a conductive material. The positive electrode plate 22 contains a lithium-transition metal composite oxide containing manganese. Specifically, the positive electrode plate 22 contains a lithium-transition metal composite oxide containing manganese as a positive electrode active material. As the lithium-transition metal composite oxide, a lithium-transition metal composite oxide having a layered structure, a lithium-transition metal composite oxide having a spinel structure, or the like may be used. For example, a lithium-nickel-cobalt-manganese composite oxide (NCM), a lithium-manganese composite oxide, a lithium-nickel-manganese composite oxide, a lithium-iron-nickel-manganese composite oxide, or the like may be mentioned. Note that the term “lithium-nickel-cobalt-manganese composite oxide” in the present description encompasses oxides containing major constitution elements (Li, Ni, Co, Mn, and O) and additional elements. The same is applied to other lithium-transition metal composite oxides expressed by “ . . . composite oxide”. Polyvinylidene fluoride (PVdF) or the like may be mentioned as the binder. Acetylene black (AB) or the like may be mentioned as the conductive material.

The negative electrode plate 24 has a long belt-shaped negative electrode core 24c (for example, a copper foil, a copper alloy foil, and the like) and a negative electrode active material layer 24a secured on at least one surface (preferably both surfaces) of the negative electrode core 24c. Hereinafter, “negative electrode core” may also be termed “negative electrode core body.” A plurality of negative electrode tabs 24t are disposed at one edge (the right edge in FIG. 4) in the width direction Y of negative electrode core body 24c. The plurality of negative electrode tabs 24t each protrude toward one side (the right side in FIG. 4) in the width direction Y. The plurality of negative electrode tabs 24t are disposed at intervals (intermittently) along the longitudinal direction of the negative electrode plate 24. A negative electrode tab 24t here is a part of a negative electrode core body 24c and a part (core body exposed part) where a negative electrode active material layer 24a of the negative electrode core body 24c is not formed. The plurality of negative electrode tabs 24t are stacked at one edge (the right edge in FIG. 4) in the width direction Y and constitutes a negative electrode tab group 25 including a plurality of negative electrode tabs 24t. A negative electrode current collector 60 is joined to the negative electrode tab group 25 (see FIGS. 2 to 4).

The size of the negative electrode plate 24 is not particularly restricted and may be set such that the above length L1 of the wound electrode body 20 can be achieved. That is, the length of the negative electrode plate 24 (the length of the negative electrode active material layer 24a) in the winding axis WL direction may be set to, for example, at least 10 cm, at least 20 cm, or at least 30 cm. The above length may be, for example, up to 60 cm, up to 50 cm, or up to 40 cm. In some embodiments, the length is at least 20 cm. The effect of the technique disclosed herein may be suitably achieved especially when the length L1 is at least 20 cm. Note that the above length does not include the length of the negative electrode tab 24t.

By the way, when the initial charging of the secondary battery assembly is performed, a coating may be formed on the surface of a negative electrode plate (specifically, the surface of a negative electrode active material layer) and gas derived from components (for example, moisture, constituent components of a non-aqueous electrolyte, or the like) in a secondary battery assembly can be produced in the electrode body. The gas produced in the electrode body is released from the open surface of the electrode body to the outside of the electrode body. Here, when the electrode body has a constitution, for example, like the wound electrode body 20, the gas is limitedly released only from the edge 20b, the open surface of the wound electrode body 20, and therefore, part of the produced gas tends to remain in the electrode body.

Here, the present inventors have found that highly resistive regions containing manganese may be formed in the negative electrode plate in producing a non-aqueous electrolyte secondary battery having a constitution which is provided with a wound electrode body and in which the positive electrode plate contains a lithium-transition metal composite oxide containing manganese. Since the charging reaction is hard to occur in highly resistive regions, charging unevenness can occur in a wound electrode body (specifically, in a negative electrode plate). Then, the present inventors have found that the formation of highly resistive regions can be derived from gas production during initial charging. The inventors infer the following mechanism about the phenomenon.

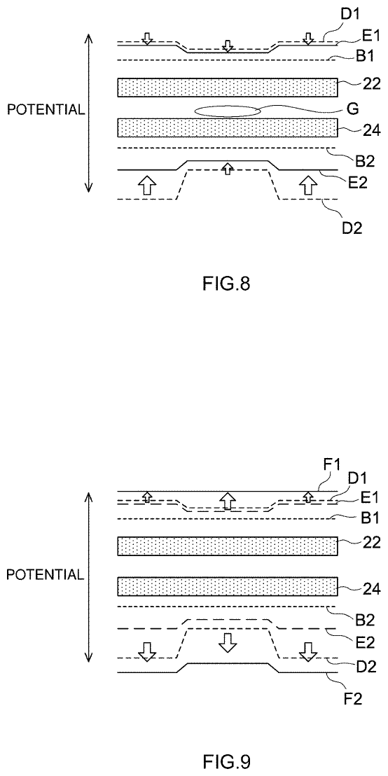

When a secondary battery assembly provided with a wound electrode body 20 is subjected to initial charging, the positive electrode potential of the wound electrode body 20 rises, and the negative electrode potential falls, as illustrated in FIG. 5. Note that a separator intervened between the positive electrode plate 22 and the negative electrode plate 24 is omitted from the illustration in FIG. 5 (the same applies to FIGS. 8 and 9). As illustrated in FIG. 5, if the gas (symbol G) remains in the wound electrode body 20 (specifically, between the positive electrode plate 22 and the negative electrode plate 24) after the initial charging, the charging reaction is hard to occur in a part facing the negative electrode plate 24. Therefore, the negative electrode potential does not fall in this part, and the negative electrode potential becomes locally higher than other parts. Accordingly, the positive electrode potential in this part becomes locally higher than other parts in the subsequent charging processing (for example, charging during high-temperature aging or the like). Here, when the positive electrode plate 22 contains a lithium-transition metal composite oxide containing manganese as a positive electrode active material, manganese may elute from the positive electrode active material by the local rise of the above positive electrode potential and precipitate on the negative electrode plate 24 (negative electrode active material layer) facing the elution part, and highly resistive regions may be formed.

In addition, the study by the present inventors revealed that the formation of highly resistive regions tends to occur at the central part 201 of the wound electrode body 20 illustrated in FIG. 3. The central part 201 refers to a region including the center line C in the width direction Y of a flat part 20a of the wound electrode body 20. A ratio (L2/L1) of the length L2 of the central part 201 to the length L1 in the same direction may be, for example, not lower than ⅙ or not lower than ¼, and not larger than ½ or not larger than ⅓. The expression “including the centerline C” means that the centerline C has only to pass the central part 201, and for example, the distance between the centerline of the central part 201 and the center line C is ¼ of L2 or smaller.

The results of an intensive study by the present inventors revealed that the formation of highly resistive regions can be suppressed by producing a non-aqueous electrolyte secondary battery using a technique disclosed herein. As illustrated in FIG. 6, this production method at least includes assembling step S1, a first charging step S2, and a discharging step S3. The assembling step S1 includes placing a wound electrode body and a non-aqueous electrolyte in a battery case to construct a secondary battery assembly. First, the wound electrode body 20 is constructed using the materials mentioned above in a conventionally known method. Next, the positive electrode current collector 50 is attached to the positive electrode tab group 23 of the wound electrode body 20, and the negative electrode current collector 60 is attached to the negative electrode tab group 25 to prepare a combined object (first combined object) of the wound electrode body and the electrode current collector (see FIG. 3). In the present embodiment, three first combined objects are prepared.

Next, three first combined objects and a sealing plate 14 are integrated to prepare a second combined object. Specifically, for example, a positive electrode terminal 30 attached in advance to the sealing plate 14 is joined to the positive electrode current collector 50 of a first combined object. Similarly, a negative electrode terminal 40 attached in advance to the lid 14 is joined to the negative electrode current collector 60 of the first combined object. Examples of join means which may be used include ultrasonic joining, resistance welding, laser welding, and the like.

Next, the second combined object is placed in the exterior body 12. Specifically, for example, three wound electrode bodies 20 are placed in an electrode body holder 70 constructed by folding an insulating resin sheet (for example, a polyolefin sheet such as a polyethylene (PE) sheet) into a bag shape or a box shape. Then, a wound electrode body 20 covered with the electrode body holder 70 is inserted into the exterior body 12. The sealing plate 14 is superimposed on the opening of the exterior body 12 in this state, the exterior body 12 and the sealing plate 14 are then welded to seal the exterior body 12. Then, a non-aqueous electrolyte is injected into the battery case 10 via the liquid injection hole 15 in a conventionally known method. The wound electrode body 20 is impregnated with the injected non-aqueous electrolyte. The secondary battery assembly in which the wound electrode body 20 and the non-aqueous electrolyte are housed in the battery case 10 is constructed in this way.

The first charging step S2 includes performing initial charging of the secondary battery assembly such that the battery voltage reaches 3.1 V to 3.7 V. In this step, initial charging of the secondary battery assembly obtained in the assembling step S1 is started using known discharging and charging means so that the battery voltage of the battery assembly reaches a desired battery voltage within the above range. In this step, it is recommended to charge the secondary battery assembly so that the depth of charge (hereinafter also appropriately referred to as “SOC: state of charge”) of the secondary battery assembly should reach a desired depth of charge within the above range. The depth of charge is preferably 5% or higher, more preferably 10% or higher, and still more preferably 15% or higher. In contrast, the depth of charge is preferably 50% or lower, more preferably 40% or lower, and still more preferably 30% or lower. The temperature condition during the initial charging is preferably 45° C. or lower, more preferably 15° C. to 35° C., and still more preferably 20° C. to 30° C. The charging rate for initial charging is not particularly restricted and may be, for example, 1 C or less. Although not particularly restricted, the first charging step S2 is preferably performed in a state where the liquid injection hole 15 is opened (that is, the battery case 10 is opened) from the point of view of releasing the gas produced by performing this step.

The discharging step S3 includes discharging the secondary battery assembly after the first charging step S2. Although the detail will be described later, this step enables to eliminate the potential unevenness in the negative electrode plate 24 and suppress the formation of highly resistive regions. In this step, the secondary battery assembly is discharged using discharging and charging means. Here, it is recommended to discharge secondary battery assembly until the battery voltage reaches a predetermined range. The battery voltage is preferably 3.2 V or lower, more preferably 3.0 V or lower, further preferably 2.8 V or lower, and preferably 2.5 V or higher. In addition, it is recommended to discharge the secondary battery assembly until the depth of charge reaches a predetermined range. The depth of charge is preferably 6% or lower, more preferably 5% or lower, and still more preferably 4% or lower.

This production method may further include a maintaining step S4, a second charging step S5, and an aging step S6. The maintaining step S4 includes maintaining the secondary battery assembly at a battery voltage of 3.2 V or lower for at least 12 hours after the discharging step S3. This step is not essential, but it is preferred to perform this step in order to exhibit the effect of the technique disclosed herein more surely. The maintaining step S4 enables to move the gas produced in the wound electrode body 20 and easily release the gas to the outside of the electrode body. The battery voltage and the depth of charge of the secondary battery assembly after the discharging step S3 can be maintained at the start of the maintaining step S4. That is, the battery voltage is preferably 3.2 V or lower, more preferably 3.0 V or lower, still more preferably 2.8 V or lower, and preferably 2.5 V or larger. The depth of charge is preferably 6% or lower, more preferably 5% or lower, still more preferably 4% or lower, and can be 0% or larger. The maintaining time may appropriately be set such that the effect of the technique disclosed herein can be achieved. For example, the maintaining time is preferably 12 hours or longer, more preferably 24 hours or longer, more preferably 48 hours or longer, and preferably 144 hours or shorter. Alternatively, the maintaining time may be 72 hours or longer and may be 120 hours or shorter. The maintaining step S4 is preferably performed in a not-high temperature state. That is, the temperature condition of this step is preferably 45° C. or lower, more preferably 40° C. or lower, and preferably 0° C. or higher, more preferably 10° C. or higher. Although not particularly restricted, the maintaining step S4 is preferably performed in a state where the liquid injection hole 15 of the sealing plate 14 is opened (that is, the battery case 10 is opened) from the point of view of releasing the produced gas.

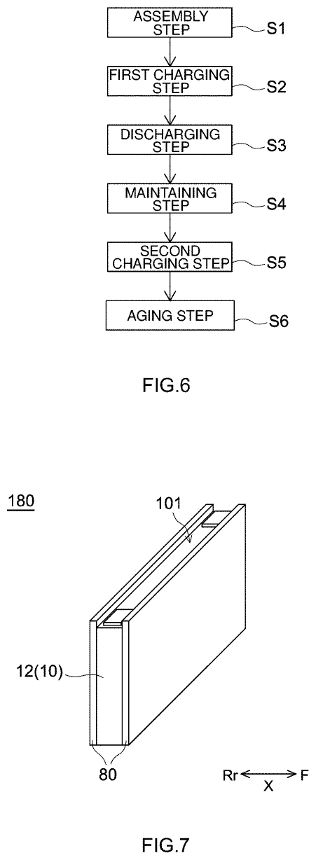

Although not particularly restricted, the maintaining step S4 is preferably performed in a state where the secondary battery assembly is restrained from the point of view of the movement and diffusion of the gas in the wound electrode body 20 or the gas release to the outside of the wound electrode body 20. It is recommended to restrain the secondary battery assembly 101 in the depth direction X (that is, the thickness direction of the wound electrode body 20 (see FIG. 3 or the like)) of the battery case 10, as illustrated in FIG. 7. Specifically, it is recommended to dispose a pair of restraining jigs 80 so as to face the entire surfaces of a pair of large-area side walls 12b (see FIG. 1) of the battery case 10 (exterior body 12).

In the above manner, a restrained body 180 including a secondary battery assembly 101 and a pair of restraining jigs 80. Then, for example, a predetermined restraining pressure can be imparted to the secondary battery assembly 101 by bridging both edges (that is, a pair of restraining jigs 80) in the depth direction X of the restrained body 180 with restraining belts. Although not particularly restricted, the restraining pressure is, for example, 1 kN or higher, preferably 3 kN to 15 kN, more preferably 6 kN to 10 kN. Alternatively, a predetermined restraining pressure may be imparted to each secondary battery assembly 101 by arranging a plurality of restrained bodies 180 in the depth direction X and bridging the restrained bodies at both ends with restraining belts. In this case, an elastic body such as a spring should be disposed between the restrained bodies 180 from the point of view of imparting uniform restraining pressure to each secondary battery assembly 101.

The timing to restrain the secondary battery assembly 101 is not particularly restricted and may be a timing after the first charging step S2 or may be a timing after the discharging step S3. From the point of view of more efficiently exhibiting the effect, it is recommended to restrain the secondary battery assembly 101 after the first charging step S2 and before the discharging step S3.

The second charging step S5 includes, after the maintaining step S4, charging the secondary battery assembly such that the battery voltage reaches 3.1 V to 3.7 V. In this step, charging of the secondary battery assembly after the maintaining step S4 is started using the above discharging and charging means so that the battery voltage of the battery assembly reaches a desired battery voltage within the above range. In this step, it is recommended to charge the secondary battery assembly so that the depth of charge of the secondary battery assembly can reach the desired depth of charge within the above range. The depth of charge is preferably 5% or higher, more preferably 10% or higher, and still more preferably 15% or higher. In contrast, the depth of charge is preferably 50% or lower, more preferably 40% or lower. The temperature condition of initial charging is preferably 45° C. or lower, more preferably 15° C. to 35° C., still more preferably 20° C. to 30° C. The charging rate for initial charging is not particularly restricted and may be appropriately set, for example, to 1 C or less. Note that when the secondary battery assembly is restrained as described above, it is recommended to release the restraint at the start of this step.

The aging step S6 includes aging at a high temperature on a secondary battery assembly after the second charging step S5. High-temperature aging is a treatment for retaining the secondary battery assembly in a high-temperature environment while the charged state is maintained. Here, the secondary battery assembly after the second charging step S5 is placed in a high-temperature environment while the battery voltage and the depth of charge are kept, and high-temperature aging is then started. The temperature in the high-temperature aging is not particularly restricted, and for example, 30° C. or higher, preferably 40° C. or higher, more preferably 50° C. or higher, and may be 80° C. or lower or 70° C. or lower. As stated above, a non-aqueous electrolyte secondary battery that is ready for use can be produced by performing the production method disclosed herein.

The consideration of the present inventors about the mechanism for achieving the effect of the technique disclosed herein is described with reference to FIGS. 5, 8, 9, or the like. However, it is not intended to limit the mechanism of the effect to those described in the following. The dotted line B1 and the dotted line B2 in FIGS. 5, 8, and 9 represent the positive electrode potential and the negative electrode potential before the initial charging, respectively.

The positive electrode potential and the negative electrode potential of the secondary battery assembly can change due to the initial charging from the position of the dotted line B1 or the dotted line B2 to the position indicated by the solid line D1 or the solid line D2 in FIG. 5, respectively. Next, discharging of the secondary battery assembly in the discharging step S3 may lower the positive electrode potential and raise the negative electrode potential. Specifically, the positive electrode potential lowers from the potential (dotted line D1) after the initial charging to the solid line E1, as illustrated in FIG. 8. The negative electrode potential rises from the potential (dotted line D2) after the initial charging to the solid line E2. Here, as illustrated by the solid line E2, the variation of the negative electrode potential after initial charging becomes small. Next, the state of the discharging step S3 is maintained in the maintaining step S4, whereby the gas G is released to the outside of the electrode body.

Next, charging the secondary battery assembly in the second charging step S5 may raise the positive electrode potential and lower the negative electrode potential. Specifically, the positive electrode potential rises from the potential (dotted line E1) after the discharging step S3 (or after the maintaining step S4) to the solid line F1, as illustrated in FIG. 9. The negative electrode potential lowers from the potential (dotted line E2) after the discharging step S3 (or after the maintaining step S4) to the solid line F2. Here, the occurrence of the variation in the negative electrode potential distribution is suppressed, as illustrated by the solid line F2. As described above, the discharging step S3 enables to eliminate the potential unevenness in the negative electrode plate 24 after the initial charging. Thus, the elution of manganese from the positive electrode plate 22 can be suppressed in the high-temperature aging treatment, and therefore, the formation of highly resistive regions containing manganese in the negative electrode plate 24 can be suppressed. Note that the dotted line D1 and the dotted line D2 in FIG. 9 represent the positive electrode potential and the negative electrode potential after the initial charging, respectively.

The effect for suppressing the formation of highly resistive regions can be evaluated, for example, by disjointing the wound electrode body after the high-temperature aging treatment and observing a negative electrode plate by the eye, as described in the following test examples. Alternatively, the effect may be evaluated by a conventionally known elemental analysis method.

A non-aqueous electrolyte secondary battery produced in the production method disclosed herein can be used in various uses. Examples of suitable uses include driving power sources mounted on vehicles such as battery electric vehicles (BEV), hybrid electric vehicles (HEV), or plug-in hybrid electric vehicles (PHEV). In addition, the non-aqueous electrolyte secondary battery may be used as a storage battery of a small size electric power storage device or the like. The non-aqueous electrolyte secondary battery may typically be used in the form of an assembled battery including a plurality of the secondary batteries electrically connected in series and/or in parallel.

### EXAMPLES

Hereinafter, test examples relating to the present invention are described. Note that the content of the test examples described hereinafter is not intended to limit the present invention.

Construction of Battery Assembly

Lithium-nickel-cobalt-manganese composite oxide (NCM) as a positive electrode active material, polyvinylidene fluoride (PVdF) as a binder, and acetylene black (AB) as a conductive material were weighed such that the mass ratio NCM:PVdF:AB should be 98:1:1, and mixed in N-methyl-2-pyrrolidone (NMP) to prepare positive electrode slurry. This positive electrode slurry was applied to both surfaces of a long belt-shaped positive electrode core body (an aluminum foil with a thickness of 18 μm) and dried. The resultant product was cut to a predetermined size and rolled by roll pressing to obtain a positive electrode plate provided with positive electrode active material layers on both surfaces of the positive electrode core body. The density of the positive electrode active material layer was 3.4 g/cm³, and the thickness per layer was 110 μm. The length in the longitudinal direction of the positive electrode plate was 72 m, and the length of the width direction was 242 mm.

Graphite powder (C) as a negative electrode active material, a styrene-butadiene rubber (SBR) as a binder, and carboxymethyl cellulose (CMC) as a thickening agent were weighed such that the mass ratio C:SBR:CMC should be 98:1:1 and mixed in water to prepare negative electrode slurry. This negative electrode slurry was applied to both surfaces of a long belt-shaped negative electrode core body (a copper foil with a thickness of 12 μm) and dried. The resultant product was cut to a predetermined size and rolled by roll pressing to obtain a negative electrode plate provided with negative electrode active material layers on both surfaces of the negative electrode core body. The density of the negative electrode active material layer was 1.4 g/cm³, and the thickness per layer was 200 μm. The length in the longitudinal direction of the positive electrode plate was 80 m, and the length of the width direction was 252 mm.

Next, the positive electrode plate and the negative electrode plate prepared as above were laminated via a separator (separator sheet) such that the positive and negative electrode plates face each other. This laminate was wound in the sheet longitudinal direction to construct a wound electrode body as illustrated in FIG. 4. The separator was provided with a substrate of a polyolefin porous layer and a heat resistant layer containing alumina and a resin binder. The thickness of the substrate was 16 μm, and the thickness of the heat resistant layer was 4 μm. The heat-resistant layer was formed on the surface on the positive electrode plate side. The length in the longitudinal direction of the separator was 82 m, and the length in the width direction was 260 mm.

The dimensional relationship of the wound electrode body constructed as above is as follows:

### W: 8 mm;

### L1: 260 mm; and

### H: 82 mm.

The numerals and symbols are as illustrated in FIG. 3. Specifically, W denotes the thickness of the wound electrode body 20. L1 was the width of the wound electrode body 20. H was the height of the wound electrode body 20.

Next, the wound electrode body and the lid of the battery case were connected via the positive electrode current collector and the negative electrode current collector. This product was inserted into a case main body, and the case main body and the lid were welded. Next, a non-aqueous electrolyte was injected from the liquid injection hole of a battery case (sealing plate). A non-aqueous electrolyte used was prepared by dissolving LiPF₆ as a supporting electrolyte at 1 mol/L and vinylene carbonate (VC) as an additive (a film-forming agent) at a concentration of 0.3% by weight were dissolved in a mixed solvent containing ethylene carbonate (EC), ethyl methyl carbonate (EMC), and dimethyl carbonate (DMC) in a volume ratio (25° C., 1 atm) EC:EMC:DMC of 30:40:30. A test secondary battery assembly was constructed in this way.

### Example 1

### First Charging Step

A non-aqueous electrolyte was injected into a battery case as mentioned above, and initial charging was performed under an environment of nitrogen atmosphere at 25° C. and 1 atm in a state where the injection hole of the sealing plate was opened (without sealing). In the initial charging, charging was performed at a current of 0.3 C until the depth of charge (SOC) reached 15% with respect to the specified capacity of the test secondary battery assembly. The battery voltage at the end of the initial charging was 3.5 V. The test secondary battery assembly after initial charging was restrained. Specifically, the test secondary battery assembly was restrained by a pair of restraining plates as illustrated in FIG. 7 from both sides in the thickness direction. The restraining pressure at this time was 6 kN.

Discharging Step

Next, the test secondary battery assembly after the initial charging was discharged. In this discharging, the test secondary battery assembly was discharged at a current of 0.5 C until the battery voltage of the test secondary battery assembly reached 3.0 V. The depth of charge of the test secondary battery assembly after discharging was 0%.

### Second Charging Step

Next, the restraint of the test secondary battery assembly was released. Next, the liquid injection hole of the sealing plate was sealed by a sealing member to seal the battery case tightly. Then, charging was performed at a current of 0.5 C until the depth of charge reached 35% with respect to the specified capacity of the test secondary battery assembly.

### Aging Step

Next, the test secondary battery assembly was placed under an environment at 60° C. and left for 15 hours. Finally, a test secondary battery assembly according to Example 1 was prepared in this way.

### Example 2

A maintaining step was performed between the discharging step and the second charging step. In the maintaining step in Example 2, the test secondary battery assembly after discharging was left for 24 hours under an environment of nitrogen atmosphere at 25° C. and 1 atm in a state where the liquid injection hole of the sealing plate was opened (without sealing). Steps from the first charging step to the aging step were performed in the same manner as Example 1, except that the above maintaining step was performed, and a test secondary battery assembly according to the present example was thereby prepared.

### Examples 3 and 4

Steps from the first charging step to the aging step were performed in the same manner as Example 2, except that the left time in the maintaining step was set to a time listed in the corresponding column in Table 1, and a test secondary battery assembly according to the present example was thereby prepared.

### Example 5

Steps from the first charging step to the aging step were performed in the same manner as Example 1, except that the above discharging step was omitted, and a test secondary battery assembly according to the present example was thereby prepared. Note that the mark “-” denoted in the “discharging step” column in Table 1 represents that the step is not performed. Likewise, the mark “-” denoted in the “maintaining step” column in Table 1 represents that the step is not performed (the same applies to Example 1).

Evaluation on Formation of Highly Resistive Regions

The test secondary battery assemblies relating to Examples 1 to 5 prepared in the manner mentioned above were charged at a current of 0.5 C until the depth of charge reached 0% with respect to the specified capacity of the test secondary battery assembly. Next, the test secondary battery assembly in each example was disjointed, and a negative electrode plate was washed with a washing liquid (dimethyl carbonate (DMC), 100 vol %) and dried. The negative electrode plate after drying was observed by the eye for the presence or absence of blackened parts. With respect to the disjointed negative electrode plate, a half-circle of winding was taken as 1 T (turn). The turn number in which the formation of highly resistive regions was observed by the eye in the total 35 T of the negative electrode plate is indicated in the “highly resistive regions (out of the total 35 T in the negative electrode plate)” column in Table 1. In the corresponding column in Table 1, the mark “-” indicates that the formation of highly resistive regions was not observed.

TABLE 1

| | | | | Discharging | | | | | | | Highly |
|---|---|---|---|---|---|---|---|---|---|---|---|
| | First charging step | | | step | | | | Second | | | resistive |
| | | | Battery | Battery | | | | charging | | | regions (out |
| | SOC | | voltage | voltage | Maintaining step | | | step | | | of total 35 T |
| | after | | after | after | SOC after | | | SOC after | Aging step | | in negative |
| | charging | Temperature | charging | discharging | start of | Temperature | Time | charging | Temperature | Time | electrode |
| | (%) | (° C.) | (V) | (V) | leaving (%) | (° C.) | (h) | (%) | (° C.) | (h) | plate) |
| Example 1 | 15 | 25 | 3.5 | 3.0 | — | | | 35 | 60 | 15 | 12 |
| Example 2 | | | | | 0 | 25 | 24 | | | | 7 |
| Example 3 | | | | | | | 43 | | | | — |
| Example 4 | | | | | | | 74 | | | | — |

| | | | |
|---|---|---|---|
| Example 5 | — | — | 23 |

As indicated in Table 1, a comparison between Examples 1 to 4 and Example 5 confirmed that the formation of the highly resistive regions in the negative electrode plate could be suppressed by performing the discharging step after the initial charging in the first charging step. Furthermore, a comparison between the results of Examples 1 to 4 confirmed that the effect for suppressing the formation of highly resistive regions could be enhanced by performing the maintaining step after the discharging step. In addition, a comparison between the results of Examples of 2 to 4 confirmed that the effect for suppressing the formation of highly resistive regions could be more greatly enhanced by prolonging the left time in the maintaining step.

The first embodiment mentioned above is merely an example of the production method disclosed herein. The technique disclosed herein can be performed in other embodiments. Now, other embodiments of the technique disclosed herein are described below.

### Second Embodiment

An ordinary-temperature aging step may optionally be performed between the second charging step S5 and the aging step S6 in the first embodiment in order to more surely achieve the effect of the technique disclosed herein. The ordinary-temperature aging step includes retaining the secondary battery assembly at 15° C. to 30° C. for 6 hours to 72 hours after the second charging step S5. The ordinary-temperature aging step enables to regulate the release of the gas in the electrode body produced during the step S5 and the relief of charging unevenness. Note that the production method according to the second embodiment may be the same as the production method according to the first embodiment, except that the ordinary-temperature aging step is performed.

### Third Embodiment

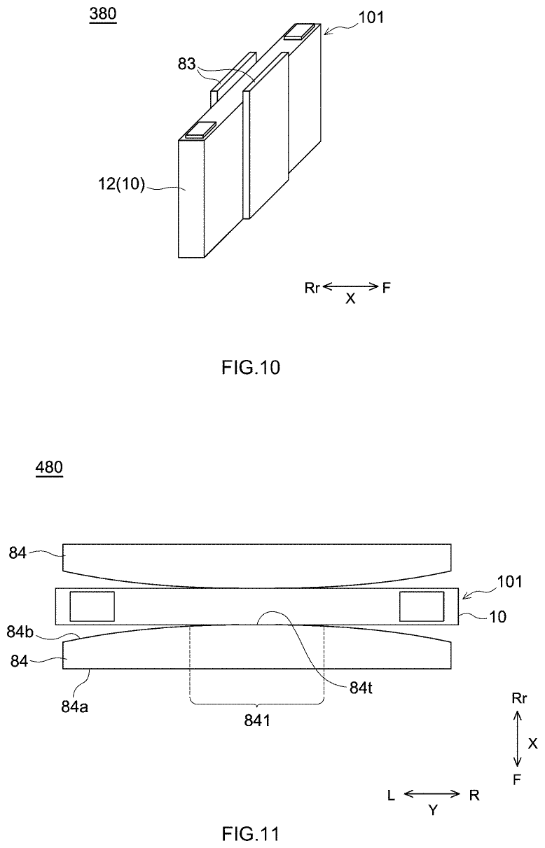

In the first embodiment, a pair of restraining jigs 80 are disposed so as to face the entire surfaces of a pair of large-area side walls 12b (see FIG. 1) of the battery case 10 (exterior body 12), as illustrated in FIG. 7. However, it is acceptable as long as a predetermined restraining pressure is imparted at least on the central part 201 of the wound electrode body 20, and the shape, dimensions, and the like of the restraining jigs are not limited as long as the predetermined restraining pressure can be imparted. It is recommended, as illustrated in FIG. 10, to sandwich the secondary battery assembly 101 by a pair of restraining jigs 83 in the depth direction X of the battery case 10 (that is, the thickness direction of the wound electrode body 20 (see FIG. 3 or the like)) in order to impart a predetermined restraining pressure on the central part 201 of the wound electrode body 20. In this manner, a restrained body 380 including a secondary battery assembly 101 and a pair of restraining jigs 83 are constructed.

Using the restraining jigs 83 imparts a predetermined restraining pressure on the central part 201 of the wound electrode body 20 but does not impart restraining pressure on the edge 202 and the edge 203. Imparting the restraining pressure selectively on the central part 201 enables to promote the gas release from the central part 201. Note that the production method according to the third embodiment may be the same as the production method according to the first embodiment, except that the restraining jigs 83 are used.

### Fourth Embodiment

Alternatively, restraining jigs 84 illustrated in FIG. 11 may be used as another example. It is recommended, as illustrated in FIG. 11, to sandwich the secondary battery assembly 101 by a pair of restraining jigs 84 in the depth direction X of the battery case 10 (that is, the thickness direction of the wound electrode body 20 (see FIG. 3 or the like)). In this manner, a restrained body 480 including the secondary battery assembly 101 and the pair of restraining jigs 84 is constructed.

Here, the restraining jigs 84 each have a flat wide surface 84a and a curved surface 84b opposing the wide surface 84a. The curved surface 84b faces the large-area side wall 12b of the battery case 10 and curves toward the large-area side wall 12b. A restraining part 841, including a curve apex 84t on the curved surface 84b is in contact with the large-area side wall 12b. Here, the position of the curve apex 84t and the length in the width direction Y of the restraining part 841 are not particularly limited and may be appropriately set such that a predetermined restraining pressure can be imparted on the central part 201 of the wound electrode body 20 by restraining. Other parts excluding the restraining part 841 on the curved surface 84b are not in contact with the large-area side wall 12b.

Using the restraining jigs 84 imparts a predetermined restraining pressure on the central part 201 of the wound electrode body 20 but does not impart restraining pressure on the edge 202 and the edge 203. Imparting the restraining pressure selectively on the central part 201 enables to promote the gas release from the central part 201. Note that the production method according to the fourth embodiment may be the same as the production method according to the first embodiment, except that the restraining jigs 84 are used.

As described above, specific embodiments disclosed herein are explained in detail, but these are mere examples and do not limit the scope of claims. The invention disclosed herein encompasses variations and modifications of the above specific embodiments changed or modified in various ways.

What is claimed is:

1. A method for producing a non-aqueous electrolyte secondary battery that comprises
a flat-shaped wound electrode body in which a belt-shaped positive electrode plate and a belt-shaped negative electrode plate are wound, with a belt-shaped separator being intervened therebetween;
a non-aqueous electrolyte; and
a battery case that houses the wound electrode body and the non-aqueous electrolyte,
the positive electrode plate comprising a lithium-transition metal composite oxide that comprises manganese,
the method comprising:
an assembling step of placing the wound electrode body and the non-aqueous electrolyte in the battery case to construct a secondary battery assembly;
a first charging step of performing initial charging on the secondary battery assembly, wherein a battery voltage of the secondary battery assembly reaches 3.1 V to 3.7 V in the first charging step; and
a discharging step of discharging the secondary battery assembly after the first charging step.

2. The production method according to claim 1, further comprising,
a maintaining step of maintaining the secondary battery assembly at a battery voltage of 3.2 V or lower for at least 12 hours after the discharging step.

3. The production method according to claim 1, wherein
the negative electrode plate comprises a negative electrode core and a negative electrode active material layer formed on the negative electrode core, and
the negative electrode active material layer has a length of at least 20 cm in a winding axis direction of the wound electrode body.

4. The production method according to claim 2, further comprising,
after the maintaining step, a second charging step of charging the secondary battery assembly, wherein a battery voltage of the secondary battery assembly reaches 3.1 V to 3.7 V in the second charging step.

5. The production method according to claim 4, further comprising,
an aging step of retaining the secondary battery assembly at 15° C. to 30° C. for 6 hours to 72 hours after the second charging step.

6. The production method according to claim 2, wherein
the secondary battery assembly is restrained in a thickness direction of the wound electrode body in the maintaining step.

7. The production method according to claim 1, wherein
the battery case comprises an exterior body that comprises an opening and a bottom part opposite to the opening, and a sealing plate that seals the opening, and
the wound electrode body is arranged in the exterior body, wherein a winding axis of the wound electrode body is parallel to the bottom part.

8. The production method according to claim 1, wherein
the wound electrode body is provided in plurality and the battery case houses the plurality of electrode bodies therein.

9. The production method according to claim 1, wherein
the non-aqueous electrolyte secondary battery comprises
a positive electrode current collector and a negative electrode current collector electrically connected to the wound electrode body,
a positive electrode tab group comprising a plurality of tabs protruding from one end in a winding axis direction of the wound electrode body, and a negative electrode tab group comprising a plurality of tabs protruding from another end in an identical direction of the wound electrode body, and
the positive electrode current collector and the positive electrode tab group are connected, and the negative electrode current collector and the negative electrode tab group are connected.
